(19) United States
(12) Patent Application Publication
(10) Pub. No.: US 2007/0131604 A1
(43) Pub. Date: Jun. 14, 2007

(54) Filter unit with deaerating mechanism

(75) Inventor: Yoshiki Nomura, Chiba-ken (JP)

Correspondence Address: Timothy J King;Entegris Inc, 129 Concord Road, Billerica, MA, 01821, US

(73) Assignee: ENTEGRIS, INC., CHASKA, MI (US)

(21) Appl. No.: 10/555,115

(22) PCT Filed: Apr. 30, 2004
(86) PCT No.: PCT/JP04/05842

§ 371 Date: Feb. 12, 2007

(30) Foreign Application Priority Data
May 1, 2003 (JP) 2003-126461

(51) Int. Cl. B01D 63/00

(52) U.S. Cl. 210/321.69; 210/321.89; 210/337; 210/443

(57) ABSTRACT

To achieve space saving and cost reduction by solving a problem with a conventional treatment fluid filtration device wherein a deaerating device and a solid particle filter device were required separately. A filter unit comprises a head part 3 having a treatment fluid inlet port 5, a filtrated fluid delivery port 7, and a deaerating port 9; a housing 1 integrally or detachably connected, in a fluid-tight manner, to the head part; a plurality of deaerating hollow fibers 33, which is housed in the housing on the upstream side; and a filter element 13 housed in the housing on the downstream side of the deaerating hollow fibers. The inlet port 5 communicates with the outer surface side of the hollow fibers 33. The delivery port communicates with the downstream side of the filter element 13. The deaeration port 9 communicates with an internal passage of the hollow fibers 33.

### CROSS REFERENCE TO RELATED APPLICATIONS

This application claims priority to PCT Application No. PCT/JP2004/005842 filed 30 Apr. 2004, which claims priority to Japanese Patent Application No. 2003-126461 filed 1 May 2003, the contents of each of these are incorporated by reference in their entirety into the present disclosure.

### BACKGROUND

It is often beneficial to remove particles, debris, dissolved gases, or bubbles of hydrogen or carbon dioxide gas from liquids used in various coating and stripping processes during semiconductor manufacturing. For example liquid chemicals such as pure water, developers, resists, solvents, coatings, and other fluids used in a lithographic or thin film coating processes may be treated by a separate degasser that removes gases and a separate filter that removes particles from the liquid. If bubbles and or particles are present in these liquids, a poor treatment of the substrate can result and it is a general practice to remove from these liquids dissolved gases or bubbles by a degasser and particles by a filter. For example, Japanese Patent Application Laying Open (KOKAI) No. 5-192658 filed by Millipore Corp., Japanese Patent Application Laying Open (KOKAI) No. 2000-15246 filed by Kikuchi, Japanese Patent Application Laying Open (KOKAI) No. 11-47508 filed by Fuji Photo Film Co., Ltd., and Japanese Patent Application Laying Open (KOKAI) No. 9-29251 filed by Kurita Water Industries Ltd.).

Previously in these treatments, a separate degassing device and separate filter device were connected in series. In the degassing device, a pressurized liquid to be treated flowed along one surface of a gas-permeable membrane while the other side of the membrane was connected to a low pressure source such as a vacuum or suction pump to remove air bubbles and dissolved gases from the liquid. The degassed or deareated liquid was then supplied to a filter device for which solid contents were removed by a filter membrane for solid separation.

### SUMMARY

The conventional technique used to separate a degassing device and filter device connected together in series has drawbacks that include increased manufacturing costs, increased space for mounting the devices, and high maintenance costs.

Embodiments of the present invention include a filter and degasser in a single housing which reduces the manufacturing cost for a device, decreases the installation space for a device, and saves labor and time required for the exchange of the device.

Embodiments of the present invention relate to a single device that can remove dissolved gases, gas bubbles, particles or any combination of these by degassing and by filtration. Embodiments of the present invention include a device in which a degasser or deaerater and a filter are contained in a single housing. Compared to separate devices, a degasser and filter in a single unit advantageously reduces production costs for manufacturing the device, space is saved during use, and the labor and time for replacement of the device are saved. A device that combines filtration and degassing or deaerating in a single housing also eliminates the pressure drop and or fluid leakage that can be associated with additional fittings and tubing used to connect the devices and can reduce the need for larger pumps.

One embodiment of the invention comprises or can include a filter unit including a head part having a treatment fluid inlet port, a filtrated fluid delivery port, and a deaeration or degassing port; a housing integrally or detachably connected, in a fluid-tight manner, to the head part; a deaerating part including a plurality of deaerating hollow fibers, which is housed in the housing; and a filter element housed in the housing on the upstream or downstream side of the deaerating part, wherein the inlet port communicates with the upstream side of the housing; the delivery port communicates with the downstream side of the housing; and the suction or degassing port communicates with an internal passage of the hollow fibers. Another embodiment of the invention is a device that includes a head portion provided with a port for a liquid to be treated, a port for filtered and degassed liquid to be removed from the device, and a port for removing gas from the liquid that has been separated from the liquid by a membrane in the device. A housing can be integrally or detachably connected with the head portion in liquid tight manner. The device includes a degassing portion that contains a degassing membrane arranged within the housing to remove gases from the liquid, and a filter element housed on the downstream side or upstream side of the degassing membrane within the housing.

In one embodiment of the present invention, the pressurized treatment fluid flows from the inlet port in the head part to the upstream side of the housing, and, in the case where the deaerating hollow fibers are present on the upstream side, it flows around the hollow fibers. Since the interior of the hollow fibers is connected to a low pressure source such as a suction pump through the suction port, a gas dissolved in the treatment solution and air bubbles permeate a membrane of the deaerating hollow fibers, and is drawn out to the outside of the unit through the internal passage of the hollow fibers. The treatment fluid from which the gas has been removed is then filtrated by the filter element for separating solid matters such as particles. The solid matters are trapped by the upstream-side surface of a filter material of the filter element and held, and the permeating fluid comes out to the delivery port in the head part as a filtrated fluid. In another embodiment of the device, a liquid to be treated can be introduced through a port on the head on the upstream side of the housing where it contacts the degassing membranes when the degassing membrane is provided on the upstream side of the device. Where the inside of the degassing membrane is connected to a reduced pressure source like a vacuum pump by way of the degassing port, bubbles and gasses dissolved in the liquid can be removed through the degassing membrane and the gases can be withdrawn to the outside of the head. The degassed liquid can then be subjected to filtration by the filter element for removal of solids such as particles and or other contaminants from the liquid. The solids and contaminants are retained by the filter material of the filter element and the filtrate is withdrawn from another port on the head of the device.

Alternatively, in the filter unit in accordance with the present invention, the pressurized treatment fluid flows from the inlet port in the head part to the upstream side of the housing, and, in the case where the filter element is present on the upstream side, it is filtrated by the filter element for separating solid matters such as particles. The solid matters are trapped by the upstream-side surface of the filter material of the filter element and held, and the permeating fluid flows around the deaerating hollow fibers as a filtrated fluid. Since the interior of the hollow fibers is connected to a low pressure source such as a suction pump through the suction port, a gas dissolved in the treatment solution and air bubbles permeate the membrane of the deaerating hollow fibers, and is drawn out to the outside of the unit through the internal passage of the hollow fibers. The filtrated fluid from which the gas has been removed then comes out to the delivery port in the head part. In another embodiment, the pressurized liquid to be treated is introduced to an inlet of the head portion of the device to the upstream side of the housing and filtered by the filter element if the filter element is provided on the upstream side to separate the particles or other solids or other contaminants such as ions which are retained by the filter material of the filter element. Liquid permeated through the filter element flows around the degassing membrane as filtrate. One side of the degassing membrane can be connected to a reduced pressure source by way of the degassing, deaerating, or gas removal port, so that bubbles and gases dissolved in the liquid can be removed from the liquid to the outside of the head portion of the device.

Thus, in the present invention, the deaeration and filtration of treatment fluid can be carried out in a single housing without using separate devices. Therefore, despite a compact device, a highly efficient filter unit can be provided, and labor and time required for manufacture, exchange, and maintenance can be saved. Embodiments of the invention make it possible to perform degassing and filtration of a liquid to be treated in a single housing that eliminates at least two fluid fittings and optionally a coupling which reduces costs to manufacture and use the device. The reduced number of fittings and decreased length of the flow path minimizes the pressure drop of the device compared to individual filtration and degassing devices coupled together.

As described above, the present invention enables the deaeration and filtration to be carried out in a single housing. Therefore, despite a compact device, the filtering work and the deaerating work are performed continuously, so that a highly efficient filter unit can be provided.

In one embodiment, the hollow fibers are supported fixedly by a column and upper and lower large-diameter parts. Therefore, handling is easy, the assembling work can also be performed merely by inserting the deaerating part into the filter unit, and the hollow fiber bundle is located on the inside of the outer peripheries of the upper and lower large-diameter parts, so that a chance that the hollow fibers are damaged during the assembling process is reduced. In another embodiment, the degassing portion comprises a support such as a strut or column contained within the housing. The support includes enlarged portions integrally formed respectively with the ends of the support, and a degassing membrane extends along the support where it is retained by the enlarged portions at both ends of the degassing membrane. The enlarged portions of the support provide a path between the inside of the degassing membrane and the gas removal port.

In one embodiment, the degassing membrane is securely held by the enlarged portions of the support so that the handling of the degassing membranes is facilitated and it is sufficient for assemblage to insert the degassing portion as a unit in the housing. Also, the degassing membranes can be located inwardly of the outer diameters of the upper and lower enlarged portions, so that the possibility of the degassing membranes being damaged during an assembling operation is reduced. The upper end of the support can be provided with a vertical passage in alignment with an inlet port of the head portion, and a plurality of radial passages extending from the lower end of the vertical passage and opening to the peripheral surface of the support. With this embodiment, the liquid to be treated is permitted to flow from the upper end of the degassing membranes to a lower end of the degassing membranes and thus the contact time between the liquid and the membranes are maximized. In another preferred mode, on the upper end side of the column or support, there are provided a longitudinal passage aligned with a treatment fluid inlet flow path in a header part and a plurality of transverse passages that extend radially from the longitudinal passage and open to the peripheral surface of the column. Therefore, the treatment fluid can be supplied to the whole of the hollow fibers, so that the efficiency of deaeration can be increased.

In one embodiment, the degassing membrane can be sealed or bonded to portions of the support whereby the inner passages or inside surface of the degassing membrane are communicated with a port that can be used to remove gas from the liquid from the housing. In another preferred mode, the lower end portion of the hollow fibers is sealingly embedded in the large-diameter part of the lower end portion; the upper end portion of the hollow fibers is embedded in the large-diameter part of the upper end portion in a penetrating state; and internal holes of hollow fibers communicate with the suction port. Therefore, the treatment fluid and the gas in the internal passage of the hollow fibers flow in the counterflow direction, so that more efficient deaeration can take place.

A conduit, which can have a variety of shapes or cross sections, surrounds the degassing membrane and provides a flow passage around the support and the degassing membrane, the lower end of the conduit can be provided with a plurality of openings to guide liquid between the degassing membrane and the filter element. The surfaces of the conduit can have distribution channels; preferably the distribution channels are on a side in contact with the filter membrane. With this conduit, the liquid to be treated is constrained around the periphery of the degassing membrane, keeping contact across the all or any portion of the degassing membrane. The conduit also acts to support the filter membrane and provide fluid distribution to the filter membrane. In a preferred mode, around the degassing membrane comprising hollow fibers, a cylinder forming a flow path for the treatment fluid is provided between the column and the hollow fibers; in the lower end portion of the cylinder, a plurality of openings are provided to guide the deaerated treatment fluid to the filter element; and further the outer surface of the cylinder has distribution passages that are arranged in a lattice form to guide the deaerated treatment fluid to the upstream-side surface of the filter element. According to this configuration, the treatment fluid is kept in contact with the hollow fibers from the upper end to the lower end thereof while being restrained by the peripheral surface of the hollow fibers, thereby being deaerated sufficiently, and then is guided to the filter element on the downstream side. Further, the cylinder not only forms the flow path of the deaerating part but also serves as the distribution passage for the treatment fluid to the filtering part. Also, the cylinder serves as a support body for the filtration material. It will be apparent that even when the filtration part formed by the filter element is provided on the upstream side and the deaerating part formed by the hollow fibers is provided on the downstream side so that the flow is reverse, the same operation and effects can be achieved.

Advantageously, embodiments of the present invention may be used to filter and degas liquids with a single device saving space, reducing the number of fluid fittings, and reducing manufacturing costs. Some processes where gas trapped in a filter membrane can reduce liquid flow through the membrane can benefit by having gas removed prior to filtration. The shortened flow path between the filter and degassing membranes can decrease pressure drop in the system compared to serially connected devices and thereby reduce the need for larger and more expensive liquid pumps. Embodiments of the present invention may be used to filter and degas liquids used in a variety of coating, film forming, cleaning, or etching processes used on substrates or other surfaces that contact the liquids.

### BRIEF DESCRIPTION OF THE DRAWINGS

In part, other aspects, features, benefits and advantages of the embodiments of the present invention will be apparent with regard to the following description, appended claims and accompanying drawings where:

FIG. 1 is a central longitudinal sectional view of a filter unit of the present invention including a deaerating or degassing part formed by hollow fibers or other degassing membrane and a filter element for separating solid matters such as particles or other contaminants;

FIG. 2 is a sectional view showing a construction of a deaerating or degassing part consisting mainly of a plurality of hollow fibers in accordance with an embodiment of the present invention;

FIG. 3 is a plan view of the deaerating or degassing part shown in FIG. 2;

FIG. 4 is a sectional view taken along the line IV-IV of FIG. 2;

FIG. 5 is a front view of a cylindrical part or conduit used in the present invention;

FIG. 6 is a plan view of the cylindrical part or conduit shown in FIG. 5;

FIG. 7 is a sectional view taken along the line VII-VII of FIG. 6;

FIG. 8 is a sectional view taken along the line VIII-VIII of FIG. 5;

FIG. 9 is a sectional view taken along the line IX-IX of FIG. 5; and

FIG. 10 is a schematic enlarged sectional view of a portion of FIG. 1.

FIG. 11 is a central longitudinal sectional view of a filter unit of the present invention including a deaerating or degassing part formed by hollow fibers or other degassing membrane and a filter element for separating solid matters such as particles or other contaminants;

FIG. 12 is a sectional view showing a construction of a deaerating or degassing part consisting mainly of a plurality of hollow fibers in accordance with an embodiment of the present invention;

FIG. 13 is a plan view of the deaerating or degassing part shown in FIG. 12.

### DESCRIPTION

Before the present compositions and methods are described, it is to be understood that this invention is not limited to the particular molecules, compositions, methodologies or protocols described, as these may vary. It is also to be understood that the terminology used in the description is for the purpose of describing the particular versions or embodiments only, and is not intended to limit the scope of the present invention which will be limited only by the appended claims.

It must also be noted that as used herein and in the appended claims, the singular forms “a”, “an”, and “the” include plural reference unless the context clearly dictates otherwise. Thus, for example, reference to a “hollow fibers” is a reference to one or more hollow fibers and equivalents thereof known to those skilled in the art, and so forth. Unless defined otherwise, all technical and scientific terms used herein have the same meanings as commonly understood by one of ordinary skill in the art. Although any methods and materials similar or equivalent to those described herein can be used in the practice or testing of embodiments of the present invention, the preferred methods, devices, and materials are now described. All publications mentioned herein are incorporated by reference. Nothing herein is to be construed as an admission that the invention is not entitled to antedate such disclosure by virtue of prior invention.

In one embodiment of the invention, a deaerating or degassing part includes a column, strut, or other degassing membrane support that can extend along an axis of the housing. Large-diameter parts can be integrally formed along the portions of the support, and a degassing membrane can be bonded to the large-diameter parts or other parts of the support and extend along the support. In one embodiment, a deaerating part includes a column extending vertically along the axis of housing, large-diameter parts integrally formed in the upper and lower portions of the column, and a plurality of hollow fibers or hollow yarns which are supported by the upper and lower large-diameter parts and extend along the column. In some embodiments, an inner portion of the support may be open or hollow and covered with the degassing membrane. A conduit or channel can be formed in the support that provides a flow path between the gas removing side of the degassing membrane and a gas removal port on the head.

According to this construction, the degassing membrane such as hollow fibers are easy to handle because they are supported fixedly by the column and the upper and lower large-diameter parts, the assembling work can also be performed merely by inserting the deaerating or degassing part into a filter unit, and the hollow fibers or other degassing membrane can be located on the inside of the outer peripheries of the upper and lower large-diameter parts. Therefore, a chance that the degassing membrane like hollow fibers are damaged during the assembling process is reduced.

On an end of the degassing membrane support near the liquid port, there can be a liquid flow passage in fluid communication with the liquid port in the header. One or more passages can be formed in the liquid flow passage of the support that open to the peripheral surface of the support and to a surface of the degassing membrane. In one embodiment, on the upper end side of the column, there are provided a longitudinal passage aligned with a treatment fluid inlet flow path in a header part and a plurality of transverse passages that extend radially from the lower end of the longitudinal passage and open to the peripheral surface of the column. Thereby, a treatment fluid can be allowed to flow along the hollow fibers from the upper end portion of the hollow fibers, which can prolong the period of time when the treatment fluid is in contact with the hollow fibers, so that the efficiency of deaeration or degassing can be increased.

In one embodiment, the lower end portion of the hollow fibers are embedded in the large-diameter part of the lower end portion of the support and are sealed; the upper end portion of the hollow fibers are embedded in the large-diameter part in the upper end portion of the support in a penetrating state; and internal holes of hollow fibers communicate with the suction or gas removal port. According to this configuration, the treatment fluid and the gas in an internal passage of the hollow fibers flow in the counterflow direction, so that highly efficient deaeration or degassing can take place.

In one embodiment, around the hollow fibers, a cylinder forming a flow path for a treatment fluid is provided between the column and the hollow fibers; in the lower end portion of the cylinder, a plurality of openings are provided to guide the deaerated or degassed treatment fluid to the filter element; and further the outer surface of the cylinder has distribution passages that are arranged in a lattice form to guide the deaerated or degassed treatment fluid to the upstream-side surface of the filter element. According to this configuration, the treatment fluid is kept in contact with the hollow fibers from the upper end to the lower end thereof while being restrained by the peripheral surface of the hollow fibers, thereby being deaerated or degassed efficiently, and the fluid is then guided to the filter element on the downstream side.

The filter element for removing solid matters such as particulate substances can be made up of a pleated filtering material arranged on the outer peripheral surface of the cylinder; porous external cylinders arranged around the filtering material; and an upper lid and a lower lid that seal the upper and lower ends of the filtering material in a fluid-tight manner, respectively, and the inner surface of the filtering material is supported by the outer peripheral surface of the cylinder forming a flow path for the treatment fluid. According to this configuration, the cylinder not only forms the flow path of the deaerating or degassing part but also serves as the distribution passage for the treatment fluid to the filtering material. Also, the cylinder serves as a support body for the filtering material.

As described above, in an embodiment of the present invention, the configuration may be such that the deaerating or degassing part formed by the hollow fibers is provided on the upstream side, and the filtration part formed by the filter element is provided on the downstream side. Even if the filtration part formed by the filter element is provided on the upstream side, and the deaerating part formed by the hollow fibers is provided on the downstream side, the filter unit operates in the same way.

Thereupon, if the inlet port and the delivery port are connected reversely so that the inlet port is used as the delivery port and the delivery port is used as the inlet port in the above-described embodiment, this embodiment can be implemented.

An embodiment of the present invention will be described in detail with reference to the accompanying drawings.

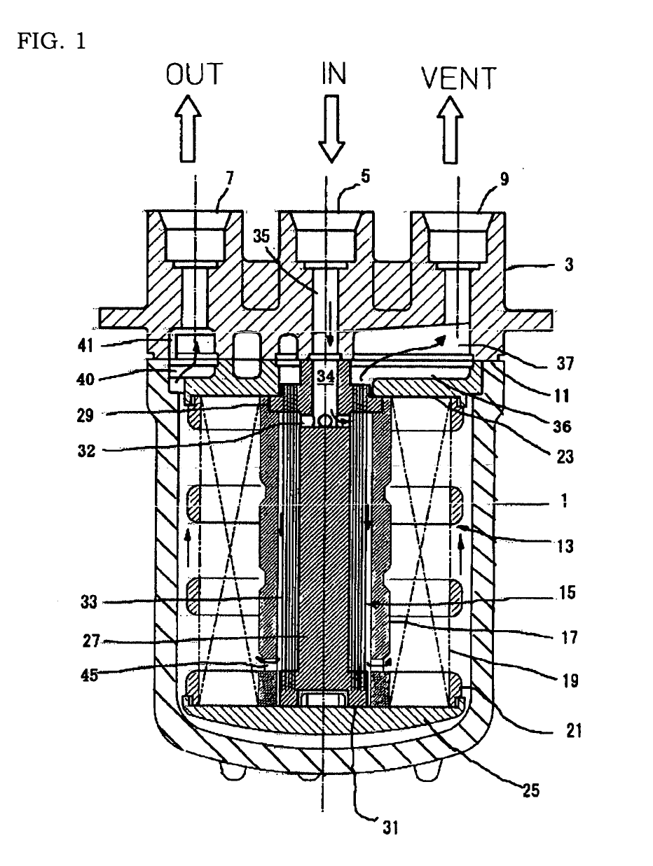

FIG. 1 is a sectional view of a filter unit of an integral type of deaeration and filtration in accordance with an embodiment of a device of the present invention. In this example, deaerating or degassing membranes are hollow fibers that are arranged on the inside of the filter unit, and a filter element for removing solid matters is arranged on the outside of the hollow fibers. However, it is apparent to those skilled in the art that the deaerating hollow fibers may be arranged in an outer peripheral portion and the filter element for removing solid matters or other contaminants may be arranged on the inside of the hollow fibers. In this case, the positions of an inlet port, delivery port, and gas removal or suction port for treatment fluid can be appropriately arranged to provide fluid contact with a membrane surface.

Also, while a deaerating part formed by the hollow fibers or other degassing membrane can be provided on the upstream side, and a filtration part formed by the filter element can be provided on the downstream side, the filter element may be provided on the upstream side and the deaerating part formed by the hollow fibers or other degassing membrane may be provided on the downstream side.

Referring to FIG. 1, the filter unit includes a fluid-tight vessel part consisting of a housing 1 and a head part 3. In the case where the housing 1 and the head part 3 are made of a synthetic resin, these elements can be butted against each other and the peripheral edge portions thereof welded to each other, by which these elements are integrated by a welding part 11. Alternatively, in the case where a metallic housing, such as that made of a synthetic resin or a stainless steel, or a synthetic resin housing is used, the peripheral edge portions thereof can be fixed to each other by tightening with an appropriate seal member therebetween. Within the housing, the degassing part formed by the degassing membrane can be arranged and the filter element arranged at the outer periphery of the deaerating part. For example, within the housing 1, the deaerating or degassing part 15 formed by the deaerating hollow fibers is arranged in the center, and the filter element (filtration part) 13 is arranged at the outer periphery of the deaerating part 15.

The head portion can have a port for introducing a liquid to be treated, a port for discharging the degassed and filtered liquid or filtrate, and a port for removing gas from a side of the degassing membrane in the housing. The gas removal port can be connected to an external reduced pressure source such as a vacuum pump. The ports can be located at various positions on the head and provide fluid communication with different membrane surfaces. For example, a gas flow passage or port can be formed in the head portion to remove gas from the insides of the degassing membrane. For example, in an embodiment of the invention shown in FIG. 1, the treatment fluid inlet port 5 can be formed in the center of the head part 3, and in the outside portion thereof, the filtrated fluid delivery port 7 and the suction port 9 connected to an outside decompression source such as a suction pump can be formed. When the treatment fluid is pressurized, the suction port need not be connected to the decompression source. On the lower surface side of the head part 3, there are formed a treatment fluid flow path 35 leading from the treatment fluid inlet port 5 to the outside of the hollow fibers (described later) constituting the hollow fiber deaerating part 15, a filtrated fluid flow path 40 and 41 for allowing the filtrated fluid flow path formed between the outer peripheral portion of the filter element 13 and the housing 1 to communicate with the filtrated fluid delivery port 7, and a gas flow path 37 for allowing the internal passage of the hollow fibers to communicate with the suction or gas removal port 9.

The degassing portion of the device includes a degassing membrane which may include hollow yarns, hollow fibers, sintered materials or other degassing membranes, and which can be installed in the housing, and in some embodiments the central or approximately central portion of the housing. The degassing portion includes a degassing membrane having a first and a second side. The first side of the degassing membrane is in fluid communication with a degassing port on the head while the second side of the membrane is in fluid communication with a liquid port on the head. The degassing membrane can be any membrane capable of allowing gases constituting the dissolved gases in the liquid or bubbles in the liquid to permeate, diffuse, flow, or by any combination of these, pass through the degassing membrane. The degassing membrane may be porous, microporous, skinned, or treated to prevent or reduce intrusion of the liquid across the degassing membrane. For example, PTFE (polytetrafluoroethylene) can be used. Examples of perfluorinated thermoplastics or their blends which are useful in the practice of this invention for the degassing membrane and or filter may also include but are not limited to [Polytetrafluoroethylene-co-perfluoromethy-1vinylether], (UFA), [Polytetrafluoroethylene-co-perfluoropropylyinylether-], (PFA), [Polytetrafluoroethylene-co-hexafluoropropylene], (FEP), and [polyvinylidene fluoride], (PVDF) or thermoplastics including any of these. Both PFA Teflon® and FEP Teflon® thermoplastics are manufactured by DuPont, Wilmington, Del. Neoflon® PFA is a polymer available from Daikin Industries. MFA Haflon® is a polymer available from Ausimont USA Inc. Thorofare, N.J. Methods and materials for making perfluorinated hollow fibers include those disclosed in U.S. Pat. No. 6,582,496 and U.S. Pat. No. 6,805,731 to Chang et al. which are incorporated herein by reference in their entirety. Other thermoplastics or their blends which are useful in the practice of this invention for degassing and or filter membranes include but are not limited to poly(chlorotrifluoroethylene vinylidene fluoride), polyvinylchloride, polyolefins like polypropylene, polyethylene, polymethylpentene, and ultra high molecular weight polyethylene, polyamides, polysulfones, polyetheretherketones, polycarbonates, and combinations including any of these. In some embodiments the filter membrane may remove ions from the liquid. Materials used for the membranes and filters may also be used for the housing, head, and other portions of the device.

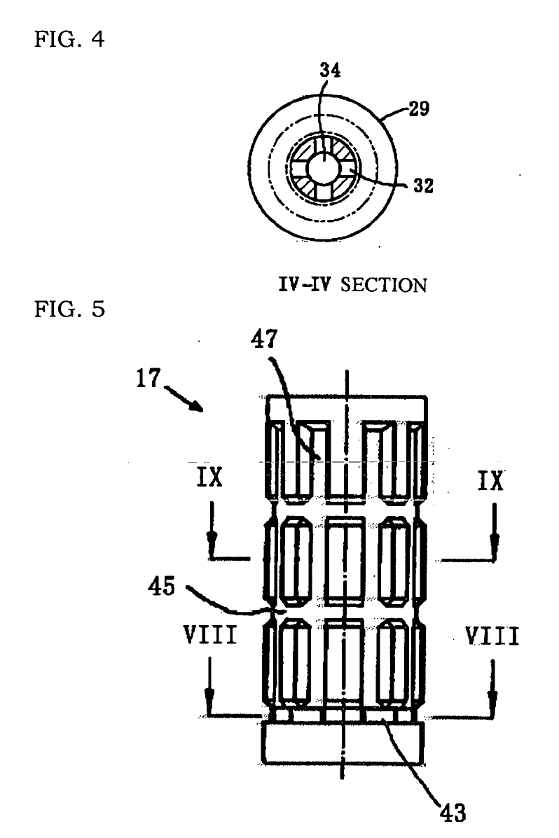

The details of a deaerating or degassing part, for example a hollow fiber deaerating part 15 housed in a central portion of the housing 1, are explained with reference to FIGS. 1 to 4. The hollow fiber deaerating part 15 includes a column or other support 27 that can extend along the axis of the housing 1. In the upper and lower end portions of the column, a large-diameter parts 29 and 31 are provided, respectively, and on the upper end side of the column 27, there are provided a passage 34 aligned with the treatment fluid flow path 35 in the head part 3 and a plurality of passages 32 that may extend radially from the lower end of the passage 34 and open to the peripheral surface of the column 27.

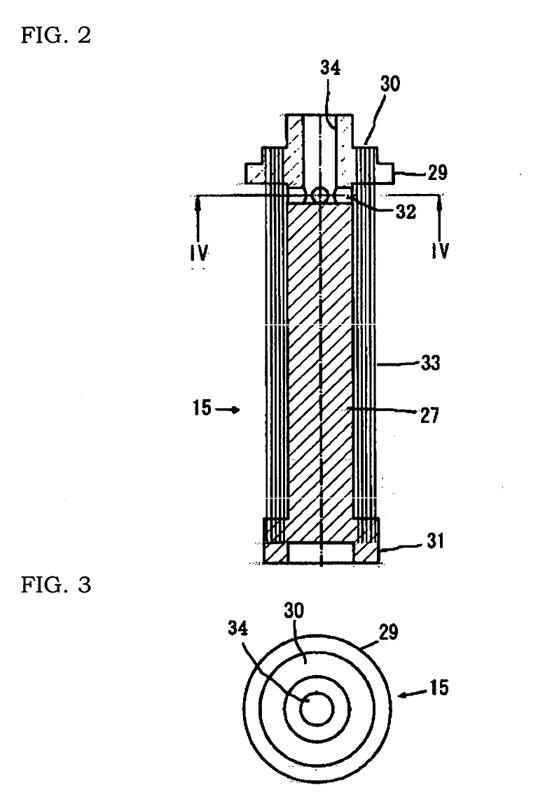

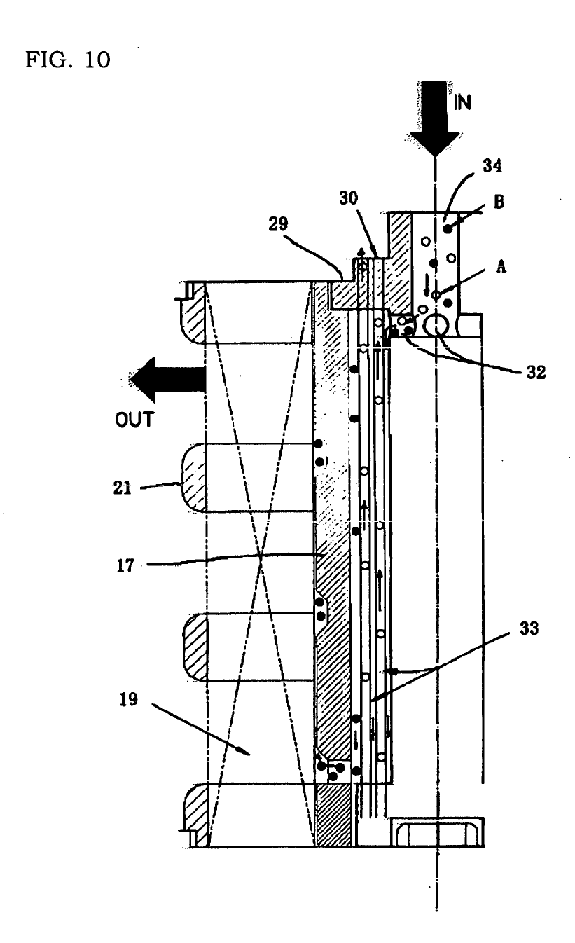

Around the column 27, a degassing membrane such as a plurality of hollow fibers (hollow fiber bundle) 33 extending along the column can be arranged. The lower end portion of the hollow fibers 33 can be embedded in the large-diameter part 31, and the internal passage of the hollow fibers can be closed by sealing. The upper end portion of the hollow fibers 33 can be embedded in the large-diameter part 29 in a penetrating state, and the internal passage of the hollow fibers leads from an opening 30 (see FIGS. 2 and 10) to a gas flow path 36. The gas flow path 36 communicates with the suction or gas removal port 9 via the flow path 37 in the head part 3. As the hollow fibers 33, a membrane that allows the permeation of a gas forming a gas dissolved in the treatment fluid under pressure or air bubbles can be used.

A conduit can be arranged around the degassing membrane to form a flow passage. For example, the conduit can have an elliptical, rectangular, or other cross sectional shape that is arranged around the degassing membrane to form a flow passage. One surface of the conduit defines a passage along the degassing membrane. The other surface supports the filter membrane. The inner or outer periphery of the conduit can optionally have distribution passages or channels to guide the liquid to or from the filter membrane. The conduit provides one or more passage between the degassing membranes and filter membranes that reduces the number of fittings and reduce pressure drop of the device compared with interconnected individual degasser and filter modules. The length of the passage or opening may be the thickness of the conduit, the size and number of the openings can be chosen to provide an acceptable pressure drop. In some embodiments, the conduit can be from about 0.1 cm to about 1 cm thick.

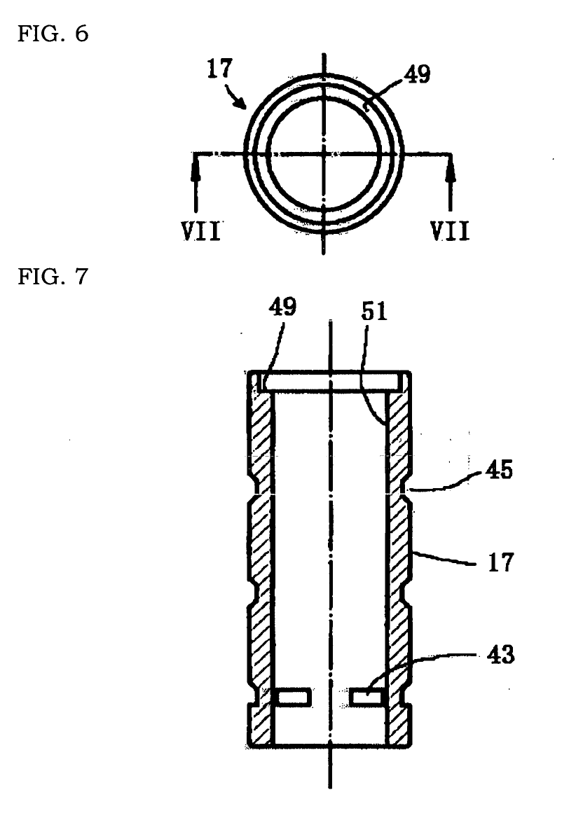

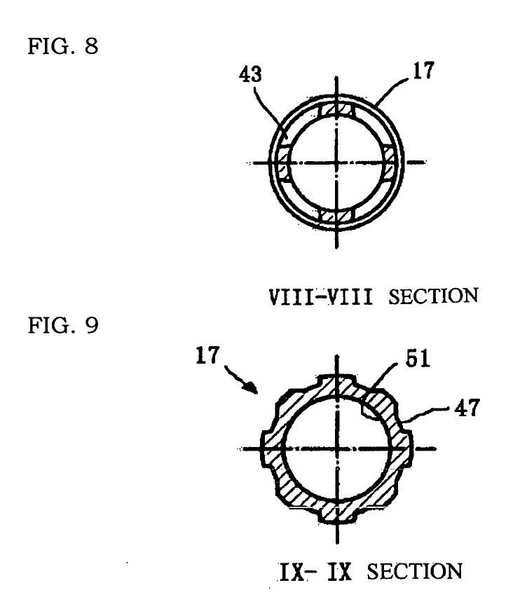

In one embodiment, around the hollow fiber deaerating part 15, a cylinder 17 for forming a flow path is provided. As shown FIGS. 1 and 5 to 9, an inner surface 51 of the cylinder 17 forms, together with the outer peripheral surface of the column 27, a flow path in which the treatment fluid flows around the hollow fiber deaerating part 15, and the outer surface of the cylinder 17 has distribution passages 45 (horizontal) and 47 (vertical) that are arranged in a lattice form to guide the deaerated treatment fluid to the inside of the filter element 13. In the lower end portion of the cylinder 17, a plurality of openings 43 are provided to guide the deaerated treatment fluid to the distribution passages 45 and 47 on the filter element 13 side.

The cylinder 17 is also used as an inside support member for the filter element 13 as described below.

The filter membrane used in the present invention can be used to remove particles as well as other contaminants, for example gels, gases, or ions, from the liquid. The filter can be a porous or microporous membrane that is supported by a surface of the conduit. The opposite side of the filter can be supported by a perforated conduit or other cage like structure. The filter can include a polymeric material, metal, ceramic, or composite and may be formed as a flat sheet, cylinder, or pleated. The filter material can be sealed to upper and lower lids to bond the upper and lower edges of the filter membrane material. The filtration membrane may be on the upstream side or downstream side of the housing. The filter material can be produced by preparing a fine porous filter membrane made of PTFE, polyethylene or any other filter material, superposing a pair of nets or non-woven fabrics for flow passages on both surfaces on the porous filter membrane, and pleating the laminate together, forming the pleated laminate into a structure, and sealing at the superposed lateral edges. The formed filter material can then heat-sealed at the upper and lower edges with the upper and lower caps. The conduit and the perforate outer support cage for the filter membrane can provide flow passages and can also act as supports for the soft and yielding filter material. The degassing membrane and the filtration membrane together share a single upper cap and or a single lower cap.

In one embodiment, as shown in FIG. 1, the filter element 13 for removing solid matters such as particulate substances is made up of a pleated filtering material 19 arranged on the outer peripheral surface of the cylinder 17, porous external cylinders 21 arranged around the filtering material 19, and an upper lid 23 and a lower lid 25 that seal the upper and lower ends of the filtering material 19 in a fluid-tight manner, respectively. The filtering material 19 is formed by putting a net or nonwoven fabric cloth for forming a flow path along both surfaces of a micro-porous filter membrane consisting of a general filter material such as PTFE or polyethylene, by bending it into a pleat form to form a ring shape, and by lapping both side edges to seal them. Further, the upper and lower edges of the filtering material 19 are thermally sealed with respect to the upper and lower lids 23 and 25, respectively. The inside cylinder 17 and the porous external cylinder 21 provide a flow path, and also reinforce and support the filtering material 19 that is susceptible to buckling.

One example of assembling of the filter unit in accordance with an embodiment of the present invention is described below. It is assumed that the housing 1, the head part 3, the hollow fiber deaerating part 15, and the filter element 13 (in a state before the upper lid 23 is sealingly attached) are in the state of having been manufactured.

First, the hollow fiber deaerating part 15 can be inserted from the upside into the internal hole of the flow path forming cylinder 17 constituting a part of the filter element 13. Design has been made so that the outside diameter of the large-diameter part 31 in the lower end portion of the column 27 of the hollow fiber deaerating part 15 is slightly smaller than the inside diameter of the cylinder 17. The upper large-diameter part 29 is positioned by a shoulder 49 provided at the upper end of the cylinder 17.

Next, the upper edge of the filtering material 19 is sealingly attached to the upper lid 23, by which the hollow fiber deaerating part 15 and the filter element 13 are formed into an integrated structure. This structure is inserted into the housing 1. The head part 3 is fixed to the housing 1 by thermally sealing or tightening means, by which the filter unit is completed. In other embodiments, this structure can then be inserted into the housing 1 and head portion 3 heat-sealed or tightened to the housing 1 by fasteners, for example but not limited to a threaded seal between the housing and head, a threaded seal and an o-ring or other gasket between the housing and head, clamps between the housing and head, nuts and bolts between the housing and head, or any combination of these with optional gasket or o-ring, to complete the filter unit.

In one embodiment a source of liquid, for example but not limited to a pressurized liquid to be treated, is introduced to liquid port on the head of the device. The liquid may contact the filtration or degassing membrane first, and then flow to contact the other membrane next. In some embodiments, the liquid initially contacts the outer surfaces of the degassing membrane during which the liquid can be gradually degassed by removal of bubbles or dissolved gas from the liquid. For example, in some embodiments and without wishing to be bound by theory or any particular mechanism, the liquid that flows across one surface of the degassing membrane can be gradually degassed by permeation. The gas removed from the liquid by the degassing membrane can be transported to the gas removal port and away from the device. The liquid passes through openings in the conduit and thus the liquid is distributed over the upstream side surface of the filter element and filtered by the filter material or membrane.

The operation of various embodiments of the invention can be explained with reference to FIGS. 1, 7 and 10. A pressurized treatment fluid supplied through the inlet port 5 flows into the upper end portion of the ring-shaped flow passage formed between the column 27 and the inner surface 51 of the cylinder 17 through the treatment fluid flow path 35, the passage 34, and the radial passage 32. The treatment fluid is deaerated gradually while being in contact with the outer surface of the hollow fibers 33 during the downward flow of treatment fluid. A permeating gas is attracted upward in the internal passage of the hollow fibers 33 as indicated by white circles in FIG. 10, and is drawn out through the suction port 9 after passing through the passages 36 and 37. On the other hand, the deaerated treatment fluid passes through the opening 43 of the cylinder 17 in the lower end portion of the hollow fibers 33 and is distributed to the upstream surface of the filtering material 19 by the guide grooves 45 and 47 formed in the outer peripheral surface of the cylinder 17, and is filtrated by the filtering material 19. Black circles in FIG. 10 indicate solid matters such as particles. On the other hand, the filtrated fluid passes through the pores in the porous external cylinders 21, flowing upward in the flow path formed between the housing 1 and the outer peripheral portion of the filter element 13, and flows out through the delivery port 7 as a deaerated filtrated fluid after passing through the flow path that includes 40 and 41.

In the above-described example, the treatment fluid is introduced through the inlet port in the central portion of the head, and the treated filtrated fluid is discharged through the delivery port provided in the peripheral portion of the head. However the function of these ports can be interchanged and, inversely, the treatment fluid can be introduced through the delivery port provided in the peripheral portion of the head, which serves as the inlet port in this case, being deaerated through the deaerating mechanism part after being filtrated, and can be discharged through the inlet port in the central portion. In this case, the treated fluid can be taken out from the center as in the conventional example.

Further, as another example, reverse to the configuration in which the deaerating mechanism is provided in the filter element as in the above-described example, the configuration may be such that the deaerating mechanism part is provided on the outside of the filter element, and the ordinarily used filter element is used as it is or with a similar construction. Specifically, the deaerating mechanism part formed by the hollow fibers is provided so as to surround the conventional filter element, by which the present invention can be configured easily as another example.

One embodiment of the invention is a device that can include a head that has a first liquid port, a second liquid port, and a gas removal port. The device can further include a housing that can be fluidly sealed to the head by fusion bonding or a mechanical seal, for example but not limited to a threaded seal, with an optional gasket or o-ring. The housing and head enclose a degassing portion, a conduit, and a filter element. The conduit is positioned between the degassing portion and the filter element and forms a flow passage between the degassing membrane and the conduit within the housing. The conduit includes fluid openings and provides support to the filter element and filter material; it may optionally include one or more distribution channels on its surfaces. The degassing portion within the housing comprises a support and a degassing membrane attached to the support. The degassing membrane has a first side and a second side, the first side of the degassing membrane is in fluid communication with the gas removal port through the support and the second side of the degassing membrane is in fluid communication with one of the liquid ports. The second side of the degassing membrane contacts a liquid to be treated that is present in the housing. The degassing membrane can include but is not limited to hollow fibers. The filter element comprises the filter material and a perforate cylinder or other suitably shaped perforate support. The filter material is supported by the perforate support and the conduit, the perforate support is in fluid communication with the other liquid port. The filter material and degassing portion can be bonded to a cap in the housing.

The device can be used to form a treated liquid by introducing a liquid into a liquid port on the head of the device and removing gas from the liquid in the housing through the degassing membrane and by removing contaminants from the liquid by the filter membrane. The treated liquid can be removed from the other liquid port on the head. The treated liquid can be dispensed onto a substrate for processes such as but not limited to cleaning, coating, developing or etching the substrate or films present on a portion or all of the substrate.

Although the present invention has been described in considerable detail with reference to certain preferred embodiments thereof, other versions are possible. Therefore the spirit and scope of the appended claims should not be limited to the description and the preferred versions contain within this specification.

For example, referring to FIG. 11, the filter unit includes a fluid-tight vessel part consisting of a housing 100 and a head part 103. In the case where the housing 100 and the head part 103 are made of a synthetic resin, these elements can be butted against each other and the peripheral edge portions thereof welded-to each other, by which these elements are integrated by a welding part 111. Alternatively, in the case where a metallic housing, such as that made of a stainless steel, or a synthetic resin housing is used, the peripheral edge portions thereof can be fixed to each other by tightening with an appropriate seal member therebetween. Within the housing, the degassing part formed by the degassing membrane can be arranged and the filter element arranged at the outer periphery of the deaerating part. For example, within the housing 100, the deaerating or degassing part 115 formed by the deaerating hollow fibers is arranged in the center, and the filter element (filtration part) 113 is arranged at the outer periphery of the deaerating part 115.

The head portion can have a port for introducing a liquid to be treated, a port for discharging the degassed and filtered liquid or filtrate, and a port for removing gas from a side of the degassing membrane in the housing. The gas removal port can be connected to an external reduced pressure source such as a vacuum pump. The ports can be located at various positions on the head and provide fluid communication with different membrane surfaces. For example, a gas flow passage or port can be formed in the head portion to remove gas from the insides of the degassing membrane. For example, in an embodiment of the invention shown in FIG. 11, the treatment fluid inlet port 105 can be formed in the center of the head part 103, and in the outside portion thereof, the filtrated fluid delivery port 107 and the suction port 109 connected to an outside decompression source such as a suction pump can be formed. When the treatment fluid is pressurized, the suction port need not be connected to the decompression source. On the lower surface side of the head part 103, there are formed a treatment fluid flow path 135 leading from the treatment fluid inlet port 105 via 134 to the outside of the hollow fibers or other degassing membrane 133 constituting the deaerating part 115, a filtrated fluid flow path 140 and 141 for allowing the filtrated fluid flow path formed between the outer peripheral portion of the filter element 113 and the housing 100 to communicate with the filtrated fluid delivery port 107. A gas flow path from opening 172 in bottom endcap 166, through open hollow fiber ends 188 to open ends 130 allows fluid communicating with channel 137 thereby allowing the internal passage of the hollow fibers or other membrane to communicate with the suction or gas removal port 109.

The degassing portion of the device includes a degassing membrane 133 which may include hollow yarns, hollow fibers, sintered materials or other degassing membranes, and which can be installed in the housing, and in some embodiments the central or approximately central portion of the housing. The degassing portion includes a degassing membrane having a first and a second side. The first side of the degassing membrane is in fluid communication with a degassing port on the head while the second side of the membrane is in fluid communication with a liquid port on the head. The degassing membrane can be any membrane capable of allowing gases constituting the dissolved gases in the liquid or bubbles in the liquid to permeate, diffuse, flow, or by any combination of these, pass through the degassing membrane. Gases can be removed from the first side of the membrane by reduced pressure, a stripping gas, by permeation, or by an act including any of these. In some embodiments the filter membrane may remove ions such as anions and cations from the liquid. Materials used for the membranes and filters may also be used for the housing, head, and other portions of the device.

The details of an embodiment of a deaerating or degassing part, for example a hollow fiber deaerating part 115 housed in a central portion of the housing 100, are explained with reference to FIGS. 12-13. The hollow fiber deaerating part 115 includes a column or other support 127 that can extend within a portion of the housing 100 or along an axis of the housing 100. In the upper and lower end portions of the column, a large-diameter parts 129 and 131 are provided, respectively, and on the upper end side of the column 127, there are provided a passage 134 aligned with the treatment fluid flow path 135 in the head part 103 and a plurality of passages 132 that may extend radially from the lower end of the passage 134 and open to the peripheral surface of the column 127.

Around the column 127, a degassing membrane such as a plurality of hollow fibers (hollow fiber bundle) 133 extending along the column can be arranged. The lower end portion 188 of the hollow fibers 133 can be open in the large-diameter part 131, and the internal passage of the hollow fibers 133 by embedding them in a penetrating state or the hollow fiber ends 188 can be open by cutting a portion of the fibers 133 and large diameter part 131 and optionally endcap 125 to open looped fiber bundles. The upper end portion of the hollow fibers 133 can be embedded in the large-diameter part 129 in a penetrating state or the hollow fiber ends 130 can be open by cutting a portion of the fibers 133 and large diameter part 129 and optionally endcap 123 to open looped fiber bundles. The internal passage of the hollow fibers lead from an opening 130 to opening 188 (see FIG. 12 ) of the hollow fibers 133 to a gas flow path 136 to 172 (see FIG. 11). The gas flow path 172 to 136 may communicate with a source of reduced pressure (not shown), a stripping gas 156 via gas removal port 109 or port 172. The flow path 137 is in fluid communication with an opening 172 in a lower endcap 166. Lower endcap 166 can be fusion bonded or otherwise fluidly sealed along periphery 160 to the housing 100. The housing 103 can be bonded or otherwise fluidly sealed along a periphery 178 to the bottom endcap 125. The housing 103 can be further bonded or attached to the head part 103 as described above. As the hollow fibers 133 are open at both ends, gas in the liquid contacting the membrane can be removed by reduced pressure, by a stripping gas 156, or by the pressure of the liquid itself. Optionally ports 109 and 172 can be connected to a valve or other flow restriction device.

The operation of various embodiments of the invention can be explained with reference to FIGS. 11 and 12. A treatment fluid supplied through the inlet port 105 flows into the upper end portion of the ring-shaped flow passage formed between the column 127 and the inner surface of the cylinder 117 through the treatment fluid flow path 135, the passage 134, and the passage 132. The treatment fluid is deaerated gradually while being in contact with the outer surface of the hollow fibers or other membrane 133 during the flow of treatment fluid. A permeating gas from the liquid, a stripping gas, or a source of reduced pressure can remove gas and or bubble from the liquid through the degassing membrane. The gas can be removed through the gas removal port 109 after passing through the passages 136 and 137. On the other hand, the deaerated treatment fluid passes through the opening 143 of the cylinder 117 in the lower end portion of the hollow fibers 133 and is distributed to the upstream surface of the filtering material 119 by the guide grooves 145 (and 147 similar to 47 not shown in FIG. 11) formed in the outer peripheral surface of the cylinder 117, and is filtrated by the filtering material 119. On the other hand, the filtrated fluid passes through the pores in the porous external cylinders 121, flowing upward in the flow path formed between the housing 100 and the outer peripheral portion of the filter element 113, and flows out through the delivery port 107 as a deaerated filtrated fluid after passing through the flow path that includes 140 and 141.

1. A filter unit comprising: a head part having a treatment fluid inlet port, a filtrated fluid delivery port, and a deaerating port; a housing integrally or detachably connected, in a fluid-tight manner, to the head part; a deaerating part including a plurality of deaerating hollow fibers, which is housed in the housing; and a filter element housed in the housing on the upstream or downstream side of the deaerating part, wherein the inlet port communicates with the upstream side of the housing; the delivery port communicates with the downstream side of the housing; and the deaerating port communicates with an internal passage of the hollow fibers.

2. A filter unit comprising: a head part having a treatment fluid inlet port, a filtrated fluid delivery port, and a deaerating port; a housing integrally or detachably connected, in a fluid-tight manner, to the head part; a deaerating part including a plurality of deaerating hollow fibers, which is housed on the upstream side of the housing; and a filter element housed in the housing on the downstream side of the deaerating part, wherein the inlet port communicates with the outer surface side of the hollow fibers; the delivery port communicates with the downstream side of the filter element; and the deaerating port communicates with an internal passage of the hollow fibers.

3. The filter unit according to claim 2, wherein the deaerating part comprises a column extending vertically along the axis of the housing; a large-diameter parts formed integrally in the upper and lower end portions of the column; and a plurality of hollow fibers that are supported by the large-diameter parts and extend along the column.

4. The filter unit according to claim 3, wherein on the upper end side of the column, there are provided a longitudinal passage aligned with a treatment fluid inlet flow path in the head part and a plurality of transverse passages that extend radially from the lower end of the longitudinal passage and open to the peripheral surface of the column.

5. The filter unit according to claim 3, wherein the lower end portion of the plurality of hollow fibers is embedded in the large-diameter part in the lower end portion and is sealed; the upper end portion of the hollow fibers is embedded in the large-diameter part in the upper end portion in a penetrating state; and internal holes of hollow fibers communicate with the suction port.

6. The filter unit according to claim 3, wherein around the hollow fibers, a cylinder forming a flow path for a treatment fluid is provided between the column and the hollow fibers; in the lower end portion of the cylinder, a plurality of openings are provided to guide the deaerated treatment fluid to the filter element; and further the outer surface of the cylinder has distribution passages that are arranged in a lattice form to guide the deaerated treatment fluid to the surface on the upstream side of the filter element.

7. The filter unit according to claim 6, wherein the filter element for removing solid matters such as particulate substances comprises a pleated filtering material arranged on the outer peripheral surface of the cylinder; porous external cylinders arranged around the filtering material; and an upper lid and a lower lid that seal the upper and lower ends of the filtering material in a fluid-tight manner, respectively, and the inner surface of the filtering material is supported by the outer peripheral surface of the cylinder forming a flow path for the treatment fluid.

8. The filter unit according to claim 2, wherein the inlet port and the delivery port are interchangeable.

9. The filter unit according to claim 4, wherein the lower end portion of the plurality of hollow fibers is embedded in the large-diameter part in the lower end portion and is sealed; the upper end portion of the hollow fibers is embedded in the large-diameter part in the upper end portion in a penetrating state; and internal holes of hollow fibers communicate with the suction port.

10. The filter unit according to claim 4, wherein around the hollow fibers, a cylinder forming a flow path for a treatment fluid is provided between the column and the hallow fibers; in the lower end portion of the cylinder, a plurality of openings are provided to guide the deaerated treatment fluid to the filter element; and further the outer surface of the cylinder has distribution passages that are arranged in a lattice form to guide the deaerated treatment fluid to the surface on the upstream side of the filter element.

11. The filter unit according to claim 5, wherein around the hollow fibers, a cylinder forming a flow path for a treatment fluid is provided between the column and the hollow fibers; in the lower end portion of the cylinder, a plurality of openings are provided to guide the deaerated treatment fluid to the filter element; and further the outer surface of the cylinder has distribution passages that are arranged in a lattice form to guide the deaerated treatment fluid to the surface on the upstream side of the filter element.

12. The filter unit according to claim 3, wherein the inlet port and the delivery port are interchangeable.

13. The filter unit according to claim 7, wherein the inlet port and the delivery port are interchangeable.

14. A device comprising:
a head having a first liquid port, a second liquid port, and a gas removal port;
a housing fluidly sealed to the head that encloses a degassing portion, a conduit, and a filter element, said conduit positioned between the degassing portion and filter element, said conduit forms a flow passage within the housing and supports the filter element;
said degassing portion comprises a degassing membrane having a first side and a second side, the first side of said degassing membrane in fluid communication with the gas removal port and the second side of the degassing membrane contacts a liquid to be treated in the housing, the second side of said degassing membrane in fluid communication with the first liquid port;
said filter element comprises the filter material and a perforate cylinder, said filter material supported by the conduit and the perforate cylinder, the perforate cylinder in fluid communication with said second liquid port.

15. The device of claim 14 wherein the degassing membrane is open at both ends.

16. The device of claim 14 wherein the filter material and degassing portion are integrally bonded to a cap in the housing.

17. The device of claim 14 wherein the degassing membrane comprises hollow fibers.

18. The device of claim 14 wherein the degassing portion is bonded to the housing.

19. A method comprising:
introducing a liquid into the device of claim 14;
removing gas from the liquid and from the housing through the degassing membrane and removing contaminants from the liquid by the filter membrane to form a treated liquid; and
removing the treated liquid from the housing.

20. She method of claim 19 further comprising the act of dispensing said treated fluid onto a substrate.
